(19) United States
(12) Patent Application Publication
(10) Pub. No.: US 2013/0130224 A1
(43) Pub. Date: May 23, 2013

(54) Method For The Analysis of Biological Samples Through Medical Ultrasound

(71) Applicant: Clorinda Victoria Contreras Villasmil, Pampatar (VE)

(72) Inventor: Clorinda Victoria Contreras Villasmil, Pampatar (VE)

(21) Appl. No.: 13/621,816

(22) Filed: Sep. 17, 2012

(30) Foreign Application Priority Data
Nov. 23, 2011 (VE) 2011-001546

(51) Int. Cl. A01N 1/02

(52) U.S. Cl. CPC A01N 1/021
USPC 435/1.1

(57) ABSTRACT

A method for the conservation of human and animal anatomical parts, both normal and pathological, which comprises a hydration phase, immersion phase and packing phase. The hydration phase comprises immersing the anatomical part in and preserving and hydrating substance. The Immersion and Packing phases comprise immersing the specimen in a gel substance contained in a polyurethane, gel latex or silicone container that allows its analysis and study by ultrasound.

### CROSS REFERENCE TO RELATED APPLICATIONS

This application claims priority of Venezuelan Patent Application 2011-001546 filed in the Venezuelan Patent Office on Nov. 23, 2011, which patent application is incorporated herein by reference.

### BACKGROUND OF THE INVENTION

Currently Anatomy is defined as the branch of medicine that studies the organs, the structures or the systems that builds the human or animal body by an anatomist in the Health Science's area (Medicine—Veterinary Medicine); generally this study is performed with parts that are preserved in formaldehyde, it preserves the tissues by a dehydration process that prevents them from decomposition. These pieces are studied and analyzed in classrooms where they are dissected in layers to separate organs and systems for a sectored study of each of its components, consequently resulting in the following disadvantages:
a. The loss of the continuity of solution of the original piece (mutilation of piece or body)
b. The formaldehyde is a derivative of methyl alcohol and is highly flammable
c. Formaldehyde is the highly volatile, it requires packaging to allow a seal, they are made generally of glass containers. This packaging are used for two purposes, it facilitates the exposure of the piece and its container; these containers have a limited resistance which increases the hazard by its manipulation.
d. The gases emanating from the formaldehyde can cause irritation of mucous membranes: oral—nose, throat and eyes, resulting in a hazard for the staff who handles anatomical specimens preserved in it.
e. In people with respiratory problems can cause irritation of the bronchial tree leading to respiratory insufficiency.
f. The formaldehyde can be lethal or fatal from 30 ppm. (1 mg/L. parts per million (ppm), is the unit of measurement for its concentration)
g. In experimental animals, it has been found that exposure for long periods of time can cause cancer.

### SUMMARY OF INVENTION

The invention includes, in one embodiment, a process for the conservation of human and animal anatomical parts, both normal and pathological, which comprises two phases in its development:
a. Hydration Phase: consists in immersing the anatomical part in a preserving and hydrating substance; and
b. Immersing and Packing Phase: immersing in a gel substance contained in a polyurethane, gel latex or silicone container that allows its analysis and study by ultrasound.

The invention provides the following advantages:
a. The conservation of all the internal and external structures (structures and systems) without the dehydration caused by the formaldehyde under a specific solution invented by me;
b. In the second phase, the piece is immersed in a solution gel that also has preserving properties, also invented by me.
c. It's hermetically sealed in a polyurethane container that allows the pass of an ultrasonic wave emitted by an echo graphic equipment, allowing an In Situs study of these pieces without the biological and work hazards that implies the handling of corpses.
d. This method can provide a true study for the medical field for the students, since the dissections and autopsies are performed only in the classes of anatomy and pathophysiology, being this last part only made by the anatomo-pathologist
e. The daily medical practice works with patients that has bodies composed by organs, structures and systems that in the real practice the evaluation of a patient is done with the use of equipment such as X-rays, Computed Axial Tomography (CAT) Scan, Magnetic Resonance Imaging (MRI) and Ultrasound; my method provides the possibility for a post-grad student to, by ultrasound and the pieces preserved by my method, practice in real-time which will result in an effective workout with real cases and parts.
f. With this method you can preserve pieces with pathologies (diseases) of high and low incidence (common cases and strange diseases) so the student can see them by ultrasound and not by books and photographs as the majority of times.
g. With this method, the student will be able to have the piece for its study for as many hours as needed.
h. With my type of sealing there will be no work hazards involving gases emanating from the old formaldehyde preparations.

In the practice of medicine, the ultrasound is a valuable tool for its great advantages: its harmless, economic and doesn't require complicated settings prior to the study or the use of substances as a contrast which in some patients it is contraindicated for its toxicity. It's a tool of easy access in the daily practice of medicine and used in almost all the specialties of the clinical practices. Every specialty studies the parts of the organs, structures, etc., by dissections, giving them a partial knowledge of the structures. That is why I offer a preservation that provides the opportunity for study by ultrasound in everyday clinical practice.

### BRIEF DESCRIPTION OF THE DRAWINGS

For a fuller understanding of the invention, reference should be made to the following detailed description, taken in connection with the accompanying drawings, in which:

FIG. 1 is a diagrammatic drawing showing a polyurethane bag;

FIG. 2 is a diagrammatic drawing showing a polyurethane bag (identified with number 1) that contains a preservative gel (identified with number 3) and anatomical specimen (identified with number 2) previously preserved in a moisturizing solution;

FIG. 3 illustrates a commercial food packaging machine;

FIG. 4 is an illustration of the vacuum sealing machine phase with a commercial food packaging (identified with number 4), in this case is sealed both the anatomical structure (identified with number 2) as the preservative gel (identified with number 3), using a bag of polyurethane as a container (identified with number 3).

FIG. 5 demonstrates the use of an anatomical specimen (identified with number 2) already hydrated and packaged in a polyurethane bag (identified with number 1) in the middle it has the preservative gel (identified with the number 3) which will be studied by an ultrasound transducer (identified with the number 5).

FIG. 6 illustrates another form of the container for the anatomical structure (identified with number 2) which is pretreated under the preservative hydration phase, but its container this time will be a block of ballistic gel (identified by number 6) it also uses the ultrasound transducer for study (identified with number 5).

FIG. 7 represents the different types of presentation of the anatomical pieces (identified with number 2) treated at the different stages of conservation, in this case it represents a cylinder swivel base made of PVC (identified with number 7) that contains the anatomical structure (identified with number 2) immersed in the preservative gel (identified with number 3) and contained in a polyurethane bag (identified with number 1), using the rotating PVC cylinder with perforations as windows.

FIG. 8 illustrates a model of an anatomical container (identified with number 8), in this case the pregnant uterus, is made of latex and it also contains a preservative gel (identified with number 3), the anatomic piece (identified with number 2), which are studied with medical ultrasound probe (identified with the number 5).

### DETAILED DESCRIPTION OF THE PREFERRED EMBODIMENT

The invention includes, in a first embodiment, a process for the conservation of anatomical pieces and immersion in preservative gel medium as a method for the analysis and study through medical ultrasound. The method includes a hydration phase, a packing phase and an immersion phase

### Hydration Phase:

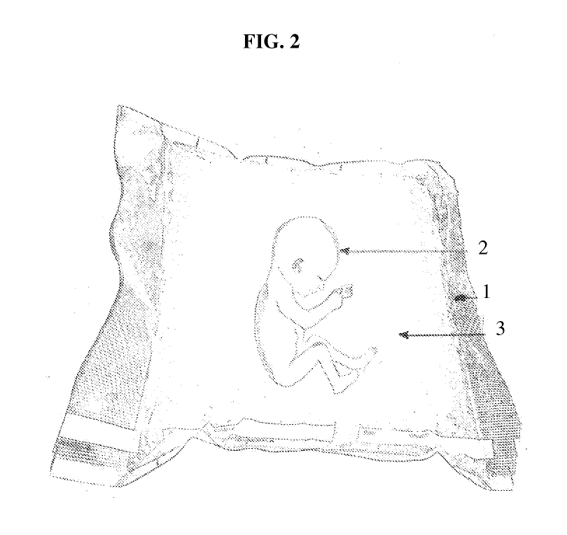

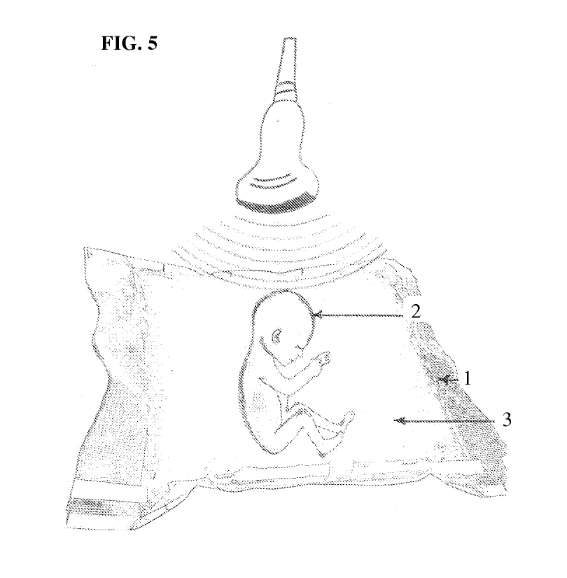

The anatomical pieces (FIG. 2, number 2) to be preserved in gel (FIG. 2, number 3) to be studied using the medical ultrasound (FIGS. 5, 6 and 8, number 5), must pass through a phase of hydration of the tissues which will preserve their anatomical characteristics, this will be achieved through immersion of the piece in a solution comprising:
a. 0.9% of Saline;
b. Glycerine;
c. Formaldehyde (if required by the piece as their state of decomposition);
d. Absolute Alcohol; and
e. Bromide dimethyl benzyl ammonium lauryl.

This phase has a duration of approximately 3 days, a period in which the desired effects will be evident by evaluating the physical characteristics of the piece that is taking part in that time period, (color-odor-elasticity-volume)

### Example I

A 500 g anatomical part could be hydrated in a solution comprising:
a. 0.9% Solution: =500 cc;
b. Glycerin: 200 cc;
c. Formaldehyde (formalin): 20 cc.; and
d. Absolute Alcohol: 200 cc

### Example II

An anatomical part previously preserved in formaldehyde could be hydrated in a solution comprising:
a. 0.9% SALINE SOLUTION=200 cc.;
b. ABSOLUTE ALCOHOL: 100 cc.; and
c. GLYCERIN: 200 cc

### Example III

A 500 g anatomical part that was not previously preserved in formaldehyde could be hydrated in a solution comprising:
a. 0.9% Saline Solution: =200 cc.;
b. Glycerin: 100 cc;
c. Formaldehyde (formalin): 20 cc.; and
d. Absolute Alcohol: 200 cc.

Packing Phase:

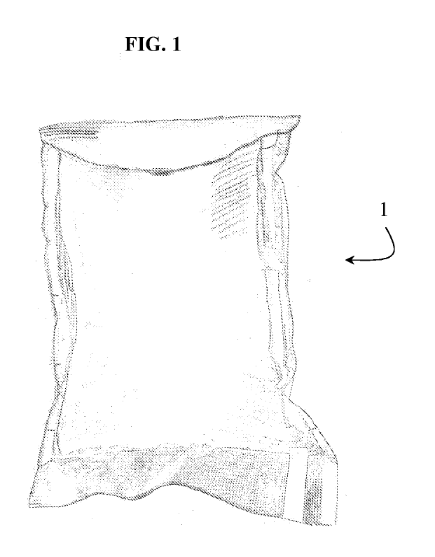

This phase belongs to all the containers (Example: FIGS. 1.-2.-4.-5.-6.-7.-) whose structure in Polymer gives transparency characteristics, elasticity and resistance, so the piece may be or not seen immersed in the gel; these containers can be made with different materials, but must provide the wave transmission of the of ultrasonic including:
a. Bags made of polyurethane. FIGS. 1.-2.-4.-.)
b. Containers of various anatomical forms or not, made of latex, blocks of ballistic gel. Silicone and polyurethane. FIGS. 5.-6.-7.-).

Proceed to fill the container (made of latex, silicone, ballistic gel or polyurethane bag (FIG. 1) designed with anatomical forms under the aesthetic presentation of the required of the piece) with preservative material (FIG. 5 Gel Preservative/number 3). Introduce the anatomical structure completely submerged and without the least possible air bubbles.

Immersion in the Preservative Gel Phase:

These anatomical parts hydrated will pass immersed in a gel (FIG. 5/number 3) which also has preservative properties comprising:
a. Carbopol;
b. Absolute Alcohol; and
c. Glycerine.

The quantities of these substances will depend on the size of the piece to be preserved. This preservative gel is obtained from a base of a commercial ultrasound gel which will add substances such as:
a. Carbapol;
b. Absolute Alcohol;
c. Glycerin; and
d. Formalin.

All these substances were used in amounts and proportions as of the size of the workpiece requires.

### Example IV

An anatomical part of 500 gs can be immersed in a gel comprising:
a. 1 gallon of any standard ultrasound gel;
b. Formaldehyde: 10 cc.;
c. Absolute Alcohol: 100 Cc.;
d. Glycerin. 50 cc.; and
e. Carbapol: 10 g.

Vacuum Sealing Phase:

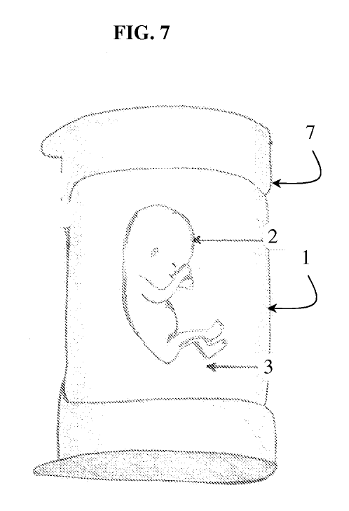

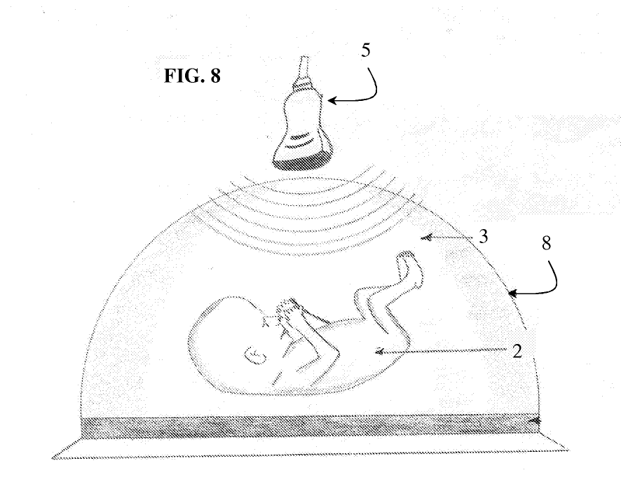

At this stage, a hermetic sealing is made using a polyurethane sealing machine (FIG. 2, number 4) to vacuum the wet material, in the case of polyurethane bags (FIGS. 1, 2-5, 7), latex or silicone (FIG. 8).

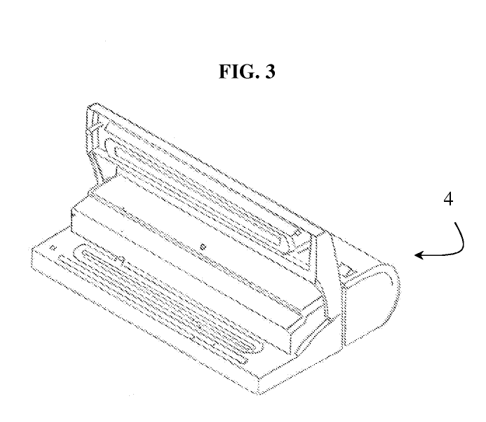

Material: (FIG. 3)

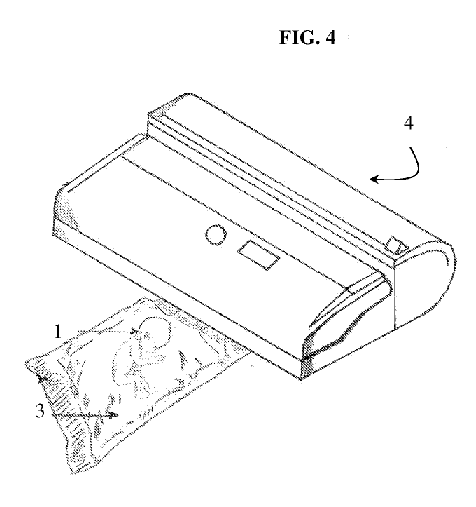

Sealing Vacuum Machine (FIG. 3-4)

This machine is a commercial sealer which seals the food bags of polyurethane for both, dry and moist products or materials. These features are applicable to this method of preserving because it seals hermetically both ends of the bag not allowing leakage of material (Preservative Gel, FIG. 5, number 3) and providing the necessary transparency for models of low complexity, where developing the orientation of spatial planes is essential for the study of ultrasound in three dimensions (Height-Width-Depth) of anatomical specimens preserved in gel.

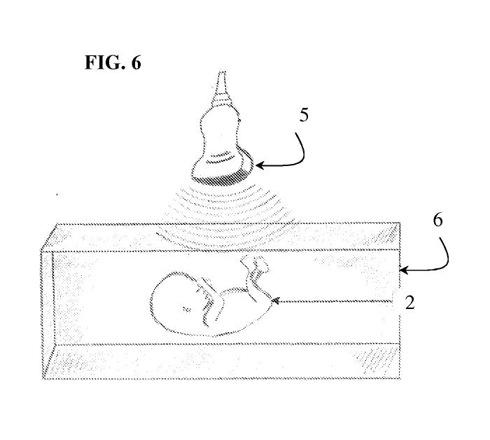

Block Moulds of Ballistic Gel (FIG. 6)

Another way of presentation of anatomical pieces (FIGS. 4-8, number 2) are to be preserved in gel by ballistic gel blocks (FIG. 6) where the ballistic gel immersion will replace the gel phase, and the piece that is submerged in the ballistic gel in its liquid phase and then upon reaching the drying time the piece will remain encrypted within a new block. This presentation was designed for models of medium complexity where there is no facility that provides transparent polyurethane bags. The student with this method will have only the guidance given by the image that provides the ultrasonic wave. It also provides convenience at the moment of handling, transportation and protection of the pieces.

Latex Anatomical Containers (FIG. 8)

Another way of presentation of anatomical pieces (FIGS. 2, 4-8, number 2) preserved previously under the method of preservation is by exposed containers with anatomical shapes (FIG. 8) aimed at simulating the human or animal anatomical structure with or without pathologies. This presentation designed for a real cosmetic and LATEX simulator. (FIG. 8).

### Example V

a. anatomical part: fetus of 20 weeks of pregnancy
b. anatomical container: latex bag shaped as a womb.

### Example VI

a. anatomical part: mammary gland
b. anatomical container: latex bag shaped as a breast

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense. Any materials, which may be cited above, are fully incorporated herein by reference.

It is also to be understood that the following claims are intended to cover all of the generic and specific features of the invention herein described, and all statements of the scope of the invention which, as a matter of language, might be said to fall there between. Relative terminology, such as “substantially” or “about,” describe the specified materials, steps, parameters or ranges as well as those that do not materially affect the basic and novel characteristics of the claimed inventions as whole (as would be appreciated by one of ordinary skill in the art). Now that the invention has been described,

What is claimed is:

1. A method of preserving an anatomical specimen comprising the steps of:
a. Hydrating the specimen in a moisturizing solution comprising a preservative;
b. Immersing the specimen in a preservative gel; and
c. Placing the specimen in an airtight container that is substantially invisible to ultrasound analysis

2. The method of claim 1, wherein the moisturizing solution comprises about 0.9% saline, absolute alcohol and glycerin.

3. The method of claim 2, wherein the moisturizing solution comprises:
a. about 200 cc 0.9% saline solution;
b. about 100 cc absolute alcohol; and
c. about 200 cc glycerin.

4. The method of claim 2, wherein the moisturizing solution further comprises at least one of formaldehyde, bromide dimethyl benzyl ammonium lauryl or a combination thereof.

5. The method of claim 4, wherein the moisturizing solution comprises, per 500 g of specimen:
a. about 500 cc of 0.9% saline solution;
b. about 200 cc of glycerin;
c. about 20 cc of formaldehyde; and
d. about 200 cc of absolute alcohol.

6. The method of claim 4, wherein the moisturizing solution comprises, per 500 g of specimen:
a. about 200 cc of 0.9% saline solution;
b. about 100 cc of glycerin;
c. about 20 cc of formaldehyde; and
d. about 200 cc of absolute alcohol.

7. The method of claim 1, wherein the preservative gel comprises;
a. Ultrasound gel;
b. Formalin;
c. Absolute Alcohol;
d. Glycerin; and
e. Carbapol.

8. The method of claim 7, wherein the preservative gel comprises, per 500 g of specimen:
a. about 1 gallon of ultrasound gel;
b. about 10 cc of formalin;
c. about 100 cc of absolute alcohol;
d. about 50 cc of glycerin; and
e. about 10 g of carbapol.

9. The method of claim 1, wherein the airtight container is selected from the group consisting of polyurethane bags, latex containers and ballistic gel blocks.

10. A moisturizing solution for the hydration of an anatomical specimen, comprising about 0.9% saline, absolute alcohol and glycerin.

11. The moisturizing solution of claim 10, wherein the moisturizing solution comprises:
a. about 200 cc 0.9% saline solution;
b. about 100 cc absolute alcohol;
c. about 200 cc glycerin.

12. The moisturizing solution of claim 10, wherein the moisturizing solution further comprises at least one of formaldehyde, bromide dimethyl benzyl ammonium lauryl or a combination thereof.

13. The moisturizing solution of claim 12, wherein the moisturizing solution comprises, per 500 g of specimen:
a. about 500 cc of 0.9% saline solution;
b. about 200 cc of glycerin;
c. about 20 cc of formaldehyde; and
d. about 200 cc of absolute alcohol.

14. The method of claim 12, wherein the moisturizing solution comprises, per 500 g of specimen:
a. about 200 cc of 0.9% saline solution;
b. about 100 cc of glycerin;
c. about 20 cc of formaldehyde; and
d. about 200 cc of absolute alcohol.

15. A gel for the preservation of anatomical specimens, comprising:
a. ultrasound gel;
b. Carbapol;
c. Absolute alcohol;
d. Glycerin; and
e. Formalin.

16. The gel of claim 15, comprising per 500 g of specimen:
a. about 1 gallon of ultrasound gel;
b. about 10 cc of formalin;
c. about 100 cc of absolute alcohol;
d. about 50 cc of glycerin; and
e. about 10 g of carbapol.
